(19) United States
(12) Patent Application Publication
(10) Pub. No.: US 2010/0103581 A1
(43) Pub. Date: Apr. 29, 2010

(54) SURGE ARRESTER HAVING A VARISTOR ARRANGEMENT AND VARISTOR MODULE FOR USE IN A SURGE ARRESTER

(75) Inventors: Bernd Kruska, Berlin (DE); Erhard Pippert, Dallgow-Doberritz Ot Seeburg (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/528,843

(22) PCT Filed: Feb. 22, 2008
(86) PCT No.: PCT/EP08/52181

§ 371 Date: Aug. 27, 2009

(30) Foreign Application Priority Data
Mar. 1, 2007 (DE) 10 2007 010 857.7

(51) Int. Cl. H01C 7/12; H02H 3/22

(52) U.S. Cl. 361/118; 338/21

(57) ABSTRACT

A surge arrester includes a varistor arrangement with a plurality of varistor modules. Electrically conductive connections are provided between the varistor modules. The electrically conductive connections are secured by coupling arrangements. Due to the use of the varistor modules, surge arresters having a variety of electrical characteristics can be implemented.

The invention relates to a surge arrester having a dissipation current path which has a varistor arrangement which has at least one first and one second varistor module which are connected to one another via an electrically conductive connection.

By way of example, a surge arrester such as this is known from European Patent Specification EP 0 963 590 B1. This document describes a surge arrester which has a varistor arrangement which is part of a dissipation current path. The varistor arrangement has a plurality of varistor modules, which make electrically conductive contact with one another with the interposition of contact disks, which act as an electrically conductive connection.

The varistor modules are essentially hollow-cylindrical in shape. In order to fix the varistor modules relative to one another, a rod passes through the varistor modules. At the end, the rod is connected to fitting bodies, in such a way that the individual varistor modules are pushed against one another. In order to fix the rod on the fitting bodies, the fitting bodies are pressed onto the rod. The pressing process permanently positions the varistor modules which are arranged between the armature bodies relative to one another.

The pressing of the armature bodies on the rod is an irreversible process. The connection can be disconnected only by destroying it.

A connection technique such as this admittedly has the advantage that it allows varistor modules to be fixed permanently over long time periods, but surge arresters which have been manufactured in this way are difficult to match to different conditions. For example, it is virtually impossible, for example, to replace defective varistor modules or to modify the surge arrester in a simple manner.

The object of the invention is therefore to specify a surge arrester of the type measured initially which can be matched to different conditions in a simple manner.

The object is achieved according to the invention, in the case of a surge arrester as mentioned initially, in that the electrically conductive connection is ensured by a coupling arrangement.

Previously known surge arresters have been designed such that there is no longer any need for repairs or adaptations after manufacture. Defective appliances were replaced and disposed of.

By the use of a coupling arrangement, it is now possible to break the electrically conductive connection and to make it again, repeatedly. It is thus possible, for example, to repair surge arresters and to replace individual varistor modules in a simple manner. In this case, the coupling arrangement can act between two adjacent varistor modules.

Various coupling arrangements can be used in this case. For example, force-fitting or interlocking coupling arrangements may be used, which are suitable for transmitting movements of one varistor module to the other varistor module. However, in addition to using rotationally rigid coupling arrangements, it is also possible to use elastic coupling arrangements. In this case, it is advantageous for the coupling arrangement to directly connect the two varistor modules to one another, thus ensuring the electrically conductive connection. For example, it is possible to interrupt the electrically conductive connection after or with the removal of the protective device, without having to intervene in the mechanism of adjacent assemblies.

According to a further advantageous refinement, the coupling arrangement may have a first and a second coupling element, with the two coupling elements being designed to correspond.

Corresponding coupling elements are designed such that they would flex during interaction at a coupling point of a coupling arrangement. Corresponding coupling elements are, for example, force-transmitted magnetic elements or friction disks, which are pressed against one another, etc.

One coupling arrangement with complementary coupling elements is, for example, an interlocking coupling arrangement. Depending on the configuration of the complementary sections, the interlock is in this case suitable for providing a stiff-angle connection or else a flexible connection.

It is also advantageously possible to provide for the coupling arrangement itself to be part of the dissipation current path.

If the coupling arrangement itself is part of the dissipation current path, that is to say the coupling arrangement acts as an electrically conductive connection in the coupled state, this can easily be integrated in the surge arrester. For example, it is possible for the electrically conductive connection itself to be represented by the coupling arrangement, with the coupling arrangement ensuring the electrical connection by virtue of its configuration.

In this case, it may be advantageous for a first and a second coupling element in each case to be arranged on one varistor module.

The arrangement of a first and a second coupling element on one varistor module allows this varistor module to be coupled repeatedly. It is therefore possible to use the varistor module, and to connect it to further varistor modules, flexibly.

In this case, according to a further advantageous refinement, the two coupling elements may be arranged on mutually averted sides of the varistor module.

The arrangement of the coupling elements on sides of the varistor module which are aligned in opposite directions to one another or face away from one another makes it possible, for example, to connect a plurality of varistor modules to one another, one behind the other like a chain, allowing the chain-like connection of coupling elements which are located between adjacent varistor modules to be released at a plurality of points.

In this case, according to a further advantageous refinement, the coupling arrangement can couple the first and the second varistor module to one another at a rigid angle.

A rigid-angle connection makes it possible to produce a rigid-angle surge arrester. By way of example, a threaded arrangement can be provided as the coupling element, with the first coupling element having an external thread and the second coupling element having an internal thread, or vice versa. These two coupling elements can be screwed to one another during coupling of the coupling arrangement, with a first and a second varistor element being pressed, as the screw force is increased. In the case of a rigid-angle connection of varistor modules such as this, it is possible to form a rigid surge arrester which is held upright on a foot point.

According to a further advantageous refinement, the coupling arrangement can couple the first and the second varistor module to one another such that they can move.

In addition to providing a rigid-angle surge arrester, it may be desirable for certain applications for the surge arrester to have a certain amount of elasticity. A correspondingly elastic configuration of the surge arrester makes it possible for the surge arrester to also withstand increased force effects, for example wind loads. By way of example, so-called chain surge arresters can be provided which are attached to a holding element, for example by being suspended. The individual varistor modules are in this case connected to one another via appropriate coupling arrangements, with the coupling arrangements also allowing relative movement between the varistor modules that have been coupled to one another, in the coupled state. An elastic coupling arrangement such as this is provided, for example, by a spherical embodiment of a first coupling element as well as a complementarily shaped second coupling element, which surrounds the spherical shape like a claw.

In addition, according to a further advantageous refinement, the varistor arrangement may have a plurality of coupling arrangements which can be operated independently of one another.

The provision of a plurality of coupling arrangements which can be coupled independently of one another allows access to different varistor modules at various points on the surge arrester. For example, it is easily possible to remove individual first modules, for example damaged varistor modules, from their assembly and to replace them by other varistor modules. It is likewise possible, depending on the prevailing electrical conditions, to adapt electrical characteristic variables of a surge arrester and to vary the response by addition or removal of one or more varistor elements. For example, it is possible at low cost to manufacture a series of surge arresters, and to match the prefabricated surge arresters to the appropriately prevailing conditions, shortly before their use.

In this case, it may be advantageous for the coupling arrangements to be arranged one behind the other, like a chain.

In a refinement variant such as this, the varistor modules form the links of a chain, with the individual links being connected to one another by coupling arrangements. In this case, it is possible for the chain to have a rigid angle between the individual varistor elements, after the electrically conductive connections have been ensured. It is thus possible, for example, to transmit holding forces via the secured electrically conductive connection and/or via the coupling arrangement. However, it is also possible to provide for the chain links to be movable relative to one another, thus restricting direct transmission of forces.

According to one advantageous refinement, at least one of the varistor modules is at least partially sheathed with an insulating material.

In order to protect the varistor modules against environmental influences, it is advantageous to provide them with an insulating material sheath. In this case, it is advantageous for this to be in the form of a jacket around the varistor module. In this case, the insulating material may, for example, also have a circumferential shield, by appropriate shaping. In this case, it is possible for the sheath of insulating material to be shaped such that a free space remains between the individual varistor modules that are coupled to one another, thus allowing relative movements between the varistor modules, without being restricted by the insulating material. However, it is also possible for the sheaths of two adjacent varistor modules to engage in one another, in such a way that the sheaths on adjacent varistor modules touch or overlap. In this case, by way of example, the insulating material sheath may cover the electrically conductive connection or the coupling arrangement, in order to protect the latter against the direct ingress of external influences.

A further object is to specify a varistor module which can be used in order to construct modifiable surge arresters in a simple manner.

According to the invention, in the case of a varistor module for use in a surge arrester, the object is achieved in that a first and a second coupling element are arranged on the varistor module, with the coupling elements being designed to correspond.

Equipping the varistor module with two correspondingly designed coupling elements, it is possible to couple a multiplicity of identical varistor modules to one another. This allows virtually any desired number of varistor modules to be connected to one another.

Furthermore, the coupling elements which are in each case located at the end after a plurality of varistor modules have been connected can be used in order to attach fitting bodies. These are then designed in a corresponding manner to the respective coupling elements located at the end. It is therefore possible to design a surge arrester in a modular form. For example, it is possible to provide surge arresters in the form of a kit of parts. A required number of varistor modules and associated fitting bodies can be assembled, depending on the operating conditions of a surge arrester. Furthermore, this allows modules to be transported in small-format dispatch boxes, in comparison to completely assembled surge arresters.

Furthermore, it may be advantageous for the coupling elements to be connected to the varistor module at a rigid angle.

A rigid-angle connection of the coupling elements to the varistor module allows versatile use of varistor modules designed in this way. For example, the coupling elements can produce a rigid-angle connection between the coupled coupling elements, in the coupled state, and forces can be passed on into the varistor module via the rigid-angled connection to the varistor module. For example, it is possible for the coupling elements to be attached to the varistor module at a rigid angle by means of cage-like surrounding windings. Furthermore, further connection methods can also be used for rigid-angle mounting of a coupling element on a varistor module.

In this case, it may be advantageous to arrange the coupling elements at a distance from one another on the varistor module.

Separating the coupling elements allows the electrical effectiveness of the varistor module not to be disadvantageously influenced. Varistor modules are suitable for having an impedance which extends to infinity when a limit value of an external electrical voltage is undershot. When the limit value is exceeded, the impedance changes over, resulting in an impedance value which tends to zero. Once the external electrical voltage has decayed below the limit value, a varistor module once again assumes its original impedance value, tending to infinity. A varistor module is therefore a voltage-dependent impedance element. Separating the coupling elements on the varistor module makes it harder for creepage current paths or parallel current paths, which could short out the varistor module, to be formed. In this case, it is advantageous for the coupling elements to be attached to surfaces of the varistor module which are aligned in opposite directions to one another.

Furthermore, it may be advantageous for at least one coupling element to form an electrically conductive current path between a connection point and the varistor module.

By way of example, a connection point may be provided in the area of a section of a coupling element which is connected during a coupling process to a corresponding coupling element. By way of example, an electrically conductive connection can be provided from this connection point via the coupling element to an attachment point on the varistor module. It is thus possible for the coupling element to represent the electrically conductive connection between two varistor modules which are arranged adjacent, and for this coupling arrangement to ensure the electrically conductive connection.

According to a further advantageous refinement, at least one coupling element can have an isolation point which interrupts a current path.

An isolation point which interrupts a current path makes it possible, for example, to bridge the isolation point by means of a removable conductor cable. For example, it is thus possible to release the conductor cable for test purposes and to isolate one installed surge arrester from further assemblies, and to tap off and/or to introduce test voltages and/or test currents, or other suitable physical variables. A current path through the isolation point is then interrupted.

According to a further advantageous refinement, the first and the second coupling element can each be coupled independently of one another.

Since the first and the second coupling element, which are arranged on a common varistor module, can be coupled independently of one another, surge arresters of virtually any desired length can be assembled. In this case, it is advantageous for the two coupling elements which are fitted to one varistor element to each be designed in a corresponding manner. It is thus possible to use a multiplicity of identically formed varistor modules and coupling arrangements.

It is advantageously also possible to provide for the varistor module to be at least partially sheathed with an insulating material.

An insulating material can be provided in order to protect the outer surface of the varistor block against external influences. In this case, it is not only possible to provide for the varistor block itself to be protected against external influences by the sheath, but also to provide for respectively provided insulating material sheaths to be shaped for a plurality of varistor blocks in the coupled state such that these sheaths overlap one another or abut against one another in such a way that the coupling areas of the varistor modules are also protected against direct external influences.

One exemplary embodiment of the invention will be described in more detail in the following text, and is illustrated schematically in the drawings, in which:

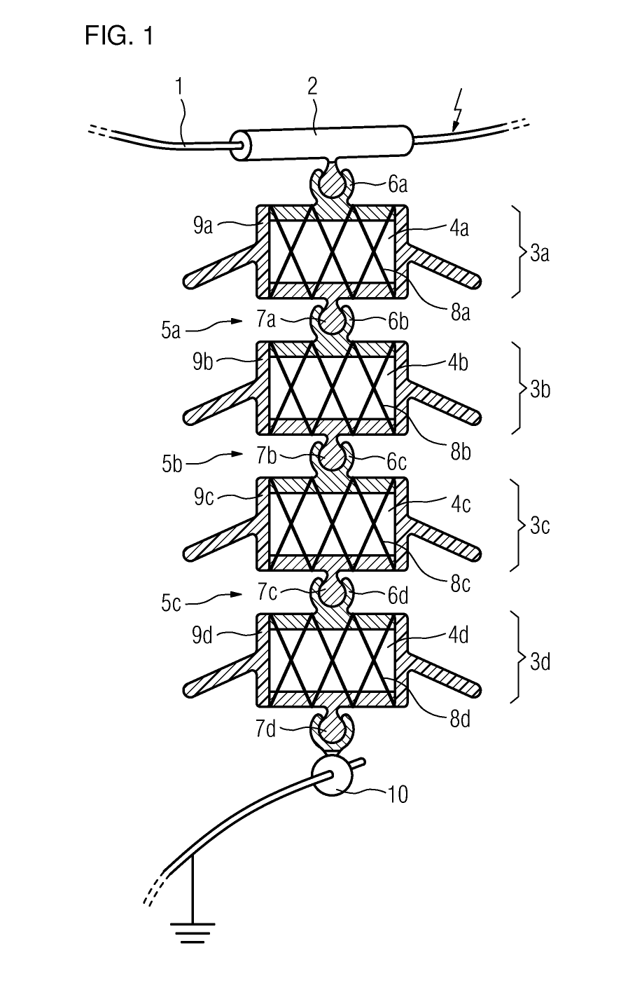

FIG. 1 shows a first embodiment variant of a modular surge arrester, and

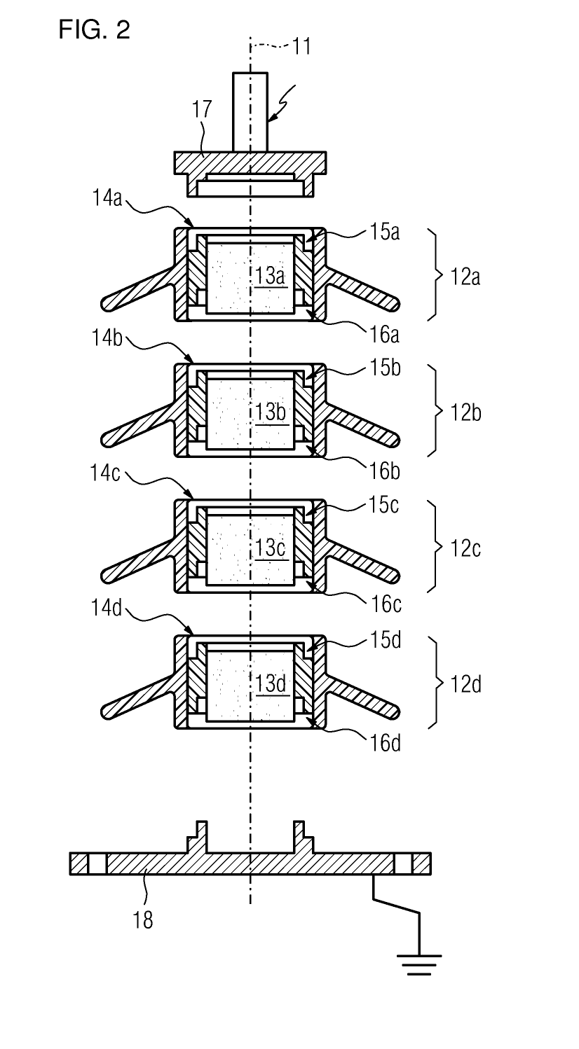

FIG. 2 shows a second embodiment variant of a modular surge arrester.

The first embodiment variant of a modular surge arrester as shown in FIG. 1 is a suspended version of a line arrester. A first connecting fitting 2 is attached to a conductor cable 1, for example an outdoor cable. The outdoor cable is used as a holding element. An electrically conductive connection to the connector cable 1 is produced at the first connecting fitting 2. Furthermore, the first connecting fitting 2 is used as the holding for the suspended modular line arrester.

The present line arrester has four identical varistor modules 3a, 3b, 3c, 3d. The four varistor modules 3a, 3b, 3c, 3d are connected to one another like a chain. Each of the varistor modules has a varistor block 4a, 4b, 4c, 4d. Each varistor block 4a, 4b, 4c, 4d has a specific response. The varistor blocks 4a, 4b, 4c, 4d make electrical contact with one another, by means of an electrically conductive connection 5a, 5b, 5c, on the mutually facing sides.

On mutually averted sides, each of the varistor modules 3a, 3b, 3c, 3d has a respective first coupling element 6a, 6b, 6c, 6d and a second coupling element 7a, 7b, 7c, 7d. The first coupling elements 6a, 6b, 6c, 6d and the second coupling elements 7a, 7b, 7c, 7d are respectively identical. In this case, the first coupling elements 6a, 6b, 6c, 6d are designed to correspond to the second coupling elements 7a, 7b, 7c, 7d. The first coupling elements 6a, 6b, 6c, 6d are in each case designed like claws, in which case the first coupling elements 6a, 6b, 6c, 6d can be inserted into the undercuts which are formed by the claws. The second coupling elements 7a, 7b, 7c, 7d are in this case spherical or cylindrical, as a result of which the first coupling elements 6a, 6b, 6c, 6d can be coupled to the second coupling elements 7a, 7b, 7c, 7d such that they can move. In the present case, both the first and the second coupling elements 7a, 7b, 7c, 7d, 6a, 6b, 6c, 6d, are formed from electrically conductive materials, for example from cast aluminum, and are part of a dissipation current path. The coupling elements 6a, 6b, 6c, 6d, 7a, 7b, 7c, 7d each make contact with the varistor blocks 4a, 4b, 4c, 4d at the end and form a large-area contact-making area. The varistor blocks 4a, 4b, 4c, 4d have an essentially cylindrical basic shape, and the coupling elements 6a, 6b, 6c, 6d, 7a, 7b, 7c, 7d have contact-making surfaces which are in each case matched to the diameter of the end faces of the varistor blocks 4a, 4b, 4c, 4d. In order to attach the coupling elements 6a, 6b, 6c, 6d, 7a, 7b, 7c, 7d to the varistor blocks 4a, 4b, 4c, 4d permanently, they are braced with respect to one another by means of an electrically insulating surrounding winding 8a, 8b, 8c, 8d, with the interposition of the varistor blocks 4a, 4b, 4c, 4d. Furthermore, other suitable attachment methods may also be used. For example, it is possible to provide for an electrically insulating sheath 9a, 9b, 9c, 9d which surrounds the varistor modules 3a, 3b, 3c, 3d to press the coupling elements 6a, 6b, 6c, 6d, 7a, 7b, 7c, 7d against one another. In the present case, the electrically insulating sheaths 9a, 9b, 9c, 9d are axially adjacent to the respective varistor blocks 3a, 3b, 3c, 3d. However, it is also possible to provide for the electrically conductive connections 5a, 5b, 5c, to be covered by overlapping sections of the electrically insulating sheaths 9a, 9b, 9c, 9d.

The varistor modules 3a, 3d which are respectively arranged at the end are connected to connecting fittings. The end varistor block 4a, which has a first coupling element 6a, is connected to the first connecting fitting 2. For this purpose, the first connecting fitting 2 has a complementary coupling element. A second connecting fitting 10 is coupled by means of the second coupling element 7d to the varistor module 3d, which is located at the opposite end of the assembly comprising the varistor modules 3a, 3b, 3c, 3d. For this purpose, the second connecting fitting 10 has a complementary coupling element to the second coupling element 7d. The second connecting fitting 10 is connected to an electrical conductor at ground potential. This therefore results in a suspended surge arrester which forms a dissipation current path, which can be switched as a function of the voltage, between a conductor cable 1 and an electrical conductor at ground potential. In this case, the dissipation path is formed between two connecting fittings 2, 10, which are arranged at the ends, and via varistor modules 3a, 3b, 3c, 3d which make electrically conductive contact with one another. The varistor modules 3a, 3b, 3c, can in this case be moved relative to one another, with electrically conductive connections 5a, 5b, 5c being used to make electrical contact. The electrically conductive connections are in the form of coupling arrangements, thus allowing the electrically conductive connections to be made and broken repeatedly.

FIG. 2 shows a second variant of a modular surge arrangement. In this case, the individual assemblies are illustrated at a distance from one another along an axis of symmetry 11. The surge arrester illustrated in FIG. 2 is designed such that it connects its individual modules to one another via rigid-angled coupling arrangements, thus allowing the modular surge arrester as shown in FIG. 2 to be installed as a so-called vertical surge arrester.

The surge arrester as shown in FIG. 2 has a plurality of varistor modules 12a, 12b, 12c, 12d, which are identical. The varistor modules 12a, 12b, 12c, 12d have a respective varistor block 13a, 13b, 13c, 13d. The varistor blocks 13a, 13b, 13c, 13d are in this case cylindrical, with each of the cylinder axes being aligned coaxially with respect to the axis of symmetry 11. The varistor blocks 13a, 13b, 13c, 13d are each coaxially surrounded by a tubular body 14a, 14b, 14c, 14d, which is formed from electrically insulating material. The tubular bodies 14a, 14b, 14c, 14d are connected at rigid angles to the respective varistor blocks 13a, 13b, 13c, 13d. On their opposite end faces, the tubular bodies 14a, 14b, 14c, 14d each have an internal thread or an external thread, with the shapes of the internal and external threads being designed to be complementary in each case. A first coupling element 15a, 15b, 15c, 15d and a second coupling element 16a, 16b, 16c, 16d are thus arranged on each of the varistor modules 12a, 12b, 12c, 12d. It is also possible to use other coupling arrangements, such as claw couplings etc.

The mutually facing ends of the respectively adjacent varistor modules 12a, 12b, 12c, 12d can be coupled to one another via the respectively associated first coupling elements 15a, 15b, 15c, 15d and the second coupling elements 16a, 16b, 16c, 16d. For this purpose, the varistor modules 12a, 12b, 12c, 12d can be coupled to one another by rotation about the rotation axis 11. The coupling process results in the varistor blocks 13a, 13b, 13c, 13d of the varistor modules 12a, 12b, 12c, 12d making electrical contact with one another, and in the individual varistor modules 12a, 12b, 12c, 12d being connected to one another at rigid angles. The electrical contact between the end faces of the varistor blocks 13a, 13b, 13c, 13d ensures an electrically conductive connection. If required, an arrangement which promotes the electrical contact, such as contact springs or the like, can also be arranged between the varistor blocks 13a, 13b, 13c, 13d. Each of the varistor modules 12a, 12d which is located at the end can be connected to corresponding connecting fittings 17, 18 by means of the respective first coupling element 15a and the second coupling element 16d located at the ends. For this purpose, the connecting fittings 17, 18 each have mutually complementary coupling elements. The connecting fittings 17, 18 are, for example, formed from an electrically conductive material and are used to complete a dissipation current path for the modular surge arrester as illustrated in FIG. 2. A first connecting fitting 17 has a contact bolt. A second connecting fitting 18 is in the form of a baseplate, as a result of which the surge arrester can be attached and held at the foot, in the assembled state.

The varistor modules 12a, 12b, 12c, 12d are each provided with an electrically insulating sheath, with this sheath being designed such that the electrically insulating sheaths of mutually adjacent varistor elements 12a, 12b, 12c, 12d are pressed against one another, as a result of which the entire length of the varistor blocks 13a, 13b, 13c, 13d is surrounded on the outside by an insulating layer. With a corresponding configuration of the terminating fittings 17, 18, for example, it is thus possible to at least partially prevent the ingress of moisture into the interior of the surge arrester as illustrated in FIG. 2.

Further rotationally rigid or elastic couplings can also be used for connection of varistor modules.

1-17. (canceled)

18. A surge arrester, comprising:
a varistor arrangement defining a dissipation current path, said varistor arrangement having at least one first varistor module and at least one second varistor module;
an electrically conductive connection connecting said first varistor module and said second varistor module to one another; and
a coupling arrangement assuring said electrically conductive connection between said varistor modules.

19. The surge arrester according to claim 18, wherein said coupling arrangement has a first coupling element and a second coupling element configured to correspond to one another.

20. The surge arrester according to claim 18, wherein said coupling arrangement forms a part of the dissipation current path.

21. The surge arrester according to claim 19, wherein a first said coupling element and a second said coupling element are in each case disposed on a respective said varistor module.

22. The surge arrester according to claim 21, wherein said coupling elements are arranged on mutually averted sides of said varistor module.

23. The surge arrester according to claim 18, wherein said coupling arrangement is configured couple said first varistor module and said second varistor module to one another at a rigid angle.

24. The surge arrester according to claim 18, wherein said coupling arrangement is configured to movably couple said first varistor module and said second varistor module to one another.

25. The surge arrester according to claim 18, which comprises a plurality of coupling arrangements operable independently of one another.

26. The surge arrester according to claim 25, wherein said coupling arrangements are disposed one behind another in a chain.

27. The surge arrester according to claim 18, which comprises insulating material at least partially sheathing at least one of said varistor modules.

28. A varistor module for a surge arrester, comprising a first coupling element and a second coupling element disposed on the varistor module, wherein said first and second coupling elements are configured to correspond to one another.

29. The varistor module according to claim 28, wherein said coupling elements are connected to the varistor module at a rigid angle.

30. The varistor module according to claim 28, wherein said coupling elements are disposed at a spacing distance from one another on the varistor module.

31. The varistor module according to claim 28, wherein at least one of said coupling elements forms an electrically conductive current path between a connecting point and the varistor module.

32. The varistor module according to claim 28, wherein at least one of said coupling elements has an isolation point configured to interrupt a current path.

33. The varistor module according to claim 28, wherein said first coupling element and said second coupling element can each be coupled independently of one another.

34. The varistor module according to claim 28, which comprises an insulating material at least partially sheathing the varistor module.
